(19) United States
(12) Patent Application Publication
(10) Pub. No.: US 2026/0167044 A1
(43) Pub. Date: Jun. 18, 2026

(54) ELECTRIC VEHICLE CHARGING/DISCHARGING MANAGEMENT DEVICE AND METHOD

(71) Applicants: HYUNDAI MOTOR COMPANY, SEOUL (KR); KIA CORPORATION, SEOUL (KR)

(72) Inventors: Na Yeon Park, Hwaseong-si (KR); Hyun Sup Kim, Hwaseong-si (KR); Min Kyu Lee, Hwaseong-si (KR); Jae Yun Jung, Hwaseong-si (KR); Bum Su Park, Hwaseong-si (KR); Dae Gun Ko, Hwaseong-si (KR); Hye Seung Han, Hwaseong-si (KR); Sung Kyu Kim, Hwaseong-si (KR); Jeong Hoon Choi, Hwaseong-si (KR)

(73) Assignees: HYUNDAI MOTOR COMPANY, SEOUL (KR); KIA CORPORATION, SEOUL (KR)

(21) Appl. No.: 19/229,559

(22) Filed: Jun. 5, 2025

(30) Foreign Application Priority Data
Dec. 13, 2024 (KR) 10-2024-0185997

(51) Int. Cl. B60L 53/64; B60L 53/66; B60L 58/12; G06Q 10/0637

(52) U.S. Cl. CPC B60L 53/64; B60L 53/66; B60L 58/12; G06Q 10/0637

(57) ABSTRACT

An electric vehicle charging/discharging management device is provided. The electric vehicle charging/discharging management device includes a communication device configured to collect vehicle data, a user interface unit configured to receive virtual data generation conditions, a first processing unit configured to learn the vehicle data and generate virtual data according to the virtual data generation conditions, a second processing unit configured to perform charging/discharging scheduling using the virtual data, and a third processing unit configured to calculate profit data according to results of the charging/discharging scheduling.

### CROSS-REFERENCE TO RELATED APPLICATION(S)

This application claims benefit of priority to Korean Patent Application No. 10-2024-0185997 filed on Dec. 13, 2024, in the Korean Intellectual Property Office, the disclosure of which is incorporated herein by reference in its entirety.

### TECHNICAL FIELD

The present disclosure relates to an electric vehicle charging/discharging management device and method, and more specifically, to an electric vehicle charging/discharging management device and method applicable to vehicle to everything (V2X) simulation technology.

### BACKGROUND

V2X simulation is a process of simulating interactions between vehicles and surroundings thereof using data from the vehicle, vehicle entry and exit by a user, and plug-in and out data for an electric vehicle. A goal thereof is to evaluate and improve the effectiveness of V2X technology in various scenarios.

V2X simulation may efficiently evaluate V2X technology by reproducing scenarios that can occur in real life, including road conditions, power supply situations, communication protocols, and the like. V2X simulation may have an advantage of being able to achieve the effects of V2X technology without incurring significant costs through testing in a virtual environment.

Such V2X simulation is a useful process for the development and optimization of V2X technology, and may help prevent possible risks and improve vulnerabilities when developed algorithms are applied to reality.

However, most of the conventional V2X simulation technologies have been implemented using vehicle entry and exit and plug-in and out virtual data based on standardized scenarios or probability.

In addition, virtual scenarios are mainly limited to charging/discharging situations at home, and thus do not sufficiently reflect various factors in the real environment.

### SUMMARY

Since virtual data for V2X simulation is generated using random numbers based on probability, it may be difficult to generate realistic data.

Therefore, the simulations of existing V2X technologies have limitations in properly simulating realistic situations and accurately evaluating effects in realistic situations.

The present disclosure is directed to providing an electric vehicle charging/discharging (e.g., charging and discharging) management device and method that may generate (e.g., highly) reliable virtual data and may predict accurate profit data using the same.

Thus, a business operation environment and a profit structure of charging station (CPO) operators and power transaction operators may be improved.

According to an aspect of the present disclosure, there is provided an electric vehicle charging/discharging management device including a communication means (e.g., communication device) configured to collect vehicle data, a user interface unit configured to receive virtual data generation conditions, a first processing unit (e.g., first processor) configured to learn the vehicle data and generate virtual data according to the virtual data generation conditions, a second processing unit (e.g., second processor) configured to perform charging/discharging scheduling using the virtual data, and a third processing unit (e.g., third processor) configured to calculate profit data according to the results of the charging/discharging scheduling.

The vehicle data may include plug-in charger information, a current SoC, a target SoC, source type information, battery capacity information, battery charging/discharging efficiency, expected vehicle entry time and expected vehicle exit time information, a plug-in time, and a plug-out time.

The virtual data generation conditions may include an initial SoC range, a date, a period, and the number of pieces of virtual data.

The device may further include a preprocessing unit (e.g., preprocessor) configured to perform normalization of the vehicle data and data combination according to properties.

The first processing unit may perform verification by comparing the virtual data with the vehicle data.

The first processing unit may perform learning by transmitting the generated virtual data and the vehicle data to the second processing unit when a probability of distinguishing between the virtual data and the vehicle data is equal to or lower than a threshold value.

The second processing unit may perform charging/discharging scheduling using the vehicle data corresponding to the virtual data generation conditions and the virtual data received from the first processing unit.

The device may further include a display unit configured to display the results of the charging/discharging scheduling and the profit data.

The first processing unit may include a TabGan model.

The third processing unit may calculate the profit data by adding the power purchase cost and the power sales cost according to the charging/discharging schedule.

According to another aspect of the present disclosure, an electric vehicle charging/discharging management method is provided. The method includes collecting, by a communication means, vehicle data, receiving, by a user interface unit, virtual data generation conditions, learning, by a first processing unit, the vehicle data, generating, by the first processing unit, virtual data according to the virtual data generation conditions, performing, by a second processing unit, charging/discharging scheduling using the virtual data, and calculating, by a third processing unit, profit data according to the results of the charging/discharging scheduling.

The vehicle data may include plug-in charger information, a current SoC, a target SoC, source type information, battery capacity information, battery charging/discharging efficiency, expected vehicle entry time and expected vehicle exit time information, a plug-in time, and a plug-out time.

The virtual data generation conditions may include an initial SoC range, a date, a period, and the number of pieces of virtual data.

The method may further include performing, by a preprocessing unit, normalization of the vehicle data and data combination according to properties, after the receiving of virtual data generation conditions.

The method may further include performing, by the first processing unit, verification by comparing the virtual data with the vehicle data, after the generating of virtual data.

The performing of verification may include comparing the virtual data with the vehicle data, calculating a probability of distinguishing between the virtual data and the vehicle data, and transmitting the generated virtual data and the vehicle data to the second processing unit when the distinguishing probability is equal to or lower than a threshold value.

The performing of charging/discharging scheduling may include performing the charging/discharging scheduling using the vehicle data corresponding to the virtual data generation conditions and the virtual data received from the first processing unit.

The method may further include displaying, by a display unit (e.g., display), results of the charging/discharging scheduling and the profit data.

The first processing unit may include a TabGan model.

The calculating of profit data may include calculating the profit data by adding the power purchase cost and the power sales cost according to the charging/discharging schedule.

### BRIEF DESCRIPTION OF THE DRAWINGS

The above and other objects and features of the present disclosure will become more apparent to those of ordinary skill in the art by describing example embodiments thereof in detail with reference to the accompanying drawings, in which:

FIG. 1 is a view of an electric vehicle power management system according to an example embodiment;

FIG. 2 is a block diagram of an electric vehicle charging/discharging management device according to an example embodiment;

FIG. 3 is a view for describing the operation of the electric vehicle charging/discharging management device according to an example embodiment;

FIGS. 4, 5, and 6 are views for describing the operation of a processor according to an example embodiment; and

FIG. 7 is a flowchart of an electric vehicle charging/discharging management method according to an example embodiment.

### DETAILED DESCRIPTION

Example embodiments of the present disclosure will be described in detail below with reference to the accompanying drawings.

The technical idea of the present disclosure is not limited to the example embodiments described and may be implemented in various different forms within the scope of the present disclosure and one or more of the components among the embodiments may be selectively combined or substituted and used.

In addition, the terms (including technical and scientific terms) used in the embodiments of the present disclosure may be interpreted as having meanings that are generally understood by a person of ordinary skill in the technical field to which the present disclosure belongs, unless defined and described, and commonly used terms such as terms provided in dictionaries may be interpreted in consideration of their contextual meaning in the related art.

Additionally, the terms used in the example embodiments of the present disclosure are for describing the embodiments and are not intended to limit the present disclosure.

In this specification, the singular may also include the plural unless the context clearly dictates otherwise, and when described as “at least one (or one or more) of A, B, and C,” it may include one or more of all possible combinations of A, B, and C.

Additionally, in describing components of embodiments of the present disclosure, terms such as first, second, A, B, (a), (b), or the like may be used.

These terms are intended to distinguish one component from another, and are not intended to limit the nature, order, or sequence of the component.

In addition, when a component is described as being “connected,” “coupled,” or “linked” to another component, it may include cases in which the component is directly connected, coupled, or linked to the other component, and also cases in which the component is “connected,” “coupled,” or “linked” by another component between the component and the other component.

Additionally, when a component is described as being formed or disposed on “on (above) or below (under)” another component, “above” or “below” includes cases in which the two components are in direct contact with each other, and also cases in which one or more other components are formed or disposed between the two components. Additionally, when expressed as “above or below,” it may include the meaning of the upward direction and also the downward direction based on a (e.g., one) component.

Hereinafter, example embodiments will be described in detail with reference to the attached drawings. Regardless of the drawing numbers, identical or corresponding components may be given the same reference numerals, and redundant descriptions thereof may be omitted.

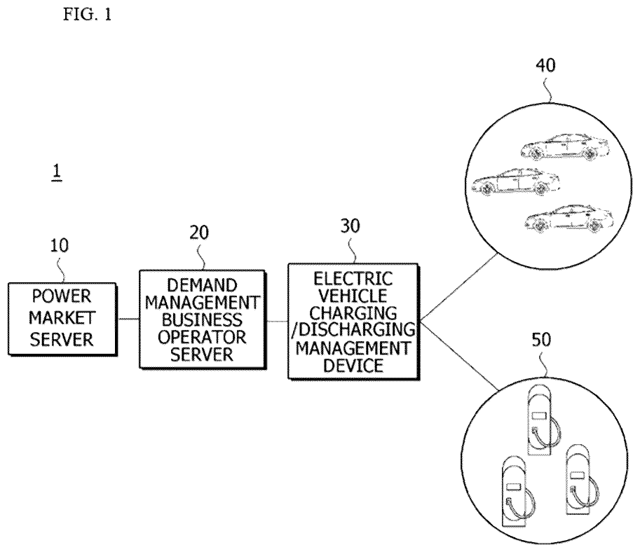

FIG. 1 is a view of an electric vehicle power management system according to an embodiment. Referring to FIG. 1, the electric vehicle power management system 1 may include a power market server 10, a demand management business operator server 20, and an electric vehicle charging/discharging management device 30.

The power market server 10 is an entity that operates a power market and may perform settlement according to a participation amount for each source in different ways according to market settlement rules. The power market server 10 may mediate power transactions between demand management business operator servers 20 using power transaction request information received from a plurality of demand management business operator servers 20.

The power market server 10 may be a server that contracts with a demand management business operator for an amount of power usage and an amount of discharge business and distributes profits to the demand management business operator through demand response and a time-based power unit price.

The demand management business operator server 20 may perform power transactions using charging/discharging information received from the linked electric vehicle charging/discharging management device 30, renewable energy generation amount information of a linked renewable energy generation system, and power demand information of a linked system.

In an example embodiment, the demand management business operator may refer to a business operator who contracts with places that use large amounts of power, such as factories, large buildings and parking towers, to reduce power consumption according to demand response, and thus gains profits.

A power system linked to the demand management business operator may transmit the power demand information to the demand management business operator server 20 at a preset cycle, at the request of the demand management business operator server or when necessary. The power demand information may include an amount of hourly power demand and power usage reduction demand for the linked system.

The demand management business operator server 20 may respond to demand response through a request to reduce the amount of power usage, and also perform a role similar to a power plant that transmits power that may be used directly in the grid using electric vehicles 40, electric vehicle batteries, ESSs, or the like.

For example, the demand management business operator server 20 may receive the next day's charging/discharging amount of the electric vehicle charging/discharging management device 30 at a specific time every day and bidding may be made on the power market server side, and the contracted amount may be received from the power market server 10 according to a preset cycle and transmitted to the electric vehicle charging/discharging management device 30.

The electric vehicle charging/discharging management device 30 (e.g., directly) manages electric vehicles 40 and charging stations 50 of customers participating in a V2X service, and may receive information on the electric vehicles 40 and chargers, plug-in/out signals, and the like. The electric vehicle charging/discharging management device 30 may determine the next day's charging/discharging bid amount with the goal of maximizing market participation profits, and may control the charging/discharging of the individual electric vehicles 40 to fulfill the contracted amount.

The electric vehicle charging/discharging management device 30 may monitor information on the electric vehicles 40 and the charging stations 50 and may provide various types of data for customers. The electric vehicle charging/discharging management device 30 may perform functions such as billing settlement, parking space management, generation and transmission of charging/discharging control commands, charging/discharging scenario control, and vehicle battery status diagnosis.

The electric vehicle charging/discharging management device 30 may include a controller 31.

The power system may include smart grid-related systems such as, for example, a substation, a power market server, a demand management business operator server, renewable sources, or an energy storage system (ESS). The renewable sources may be wind, solar, geothermal, or waste-based energy sources. The power system may supply power within a range of allowable power (or maximum power (Pmax) or allowable AC current (IACmax)) to the charging stations 50 under the control of the controller 31.

In some cases, when a large number of electric vehicles 40 are concentrated at charging stations 50 in a specific region at the same time, the maximum allowable power of the power system may vary. That is, the power market server 10 that controls a system operation, the demand management business operator server 20 or an energy management system (EMS) may deploy a reserve power source such as an energy storage system (ESS) or may deploy a surrounding renewable energy source to increase a power capacity and supply the power to the charging stations.

The allowable power may be increased by the control of the controller 31 when the power supplied to the electric vehicles 40 is insufficient due to charging demand information of each electric vehicle 40 (e.g., a charging demand amount of electric vehicle users). That is, the controller 31 may control a switch to additionally connect (e.g., deploy) a renewable energy source (or the energy storage system (ESS)) within the power system to the substation that supplies power to the charging stations 50 so that the allowable power of the power system increases when a charging load (e.g., a load of the electric vehicle) of the charging station 50 exceeds the allowable power of the power system.

The controller 31 may control the overall operation of components included in the electric vehicle charging/discharging management device 30. The controller 31 is an aggregator and may collect information on a battery capacity of the electric vehicle 40 connected to the charging station 50 through a wired or wireless communication network, a state of charge (SoC) of the battery of the electric vehicle 40, a rated current flowing through a power line, a rated voltage applied to the power line, or charging request information of an electric vehicle user (e.g., an owner). The charging request information of the electric vehicle user may be transmitted to the controller 31 through a communication means included in each of the charging stations 50 or through a communication means, such as a mobile phone of the user. The communication means may include, but are not limited to, wired communication devices such as Ethernet modems, power line communication (PLC) modules, or serial communication interfaces (e.g., RS-232, RS-485), and wireless communication devices such as Wi-Fi modules, Bluetooth transceivers, cellular modems (e.g., 4G, 5G), Zigbee modules, or dedicated short-range communication (DSRC) devices. Additionally, the communication means may encompass user devices, such as smartphones, tablets, or wearable devices, equipped with communication applications, as well as embedded communication modules within the charging stations, such as on-board diagnostic (OBD) interfaces or vehicle-to-grid (V2G) communication units.

The controller 31 may exchange information with the power system through a wired or wireless communication network, and may exchange data with the charging station 50 through a LAN connection such as Ethernet, power line communication (PLC), or Wi-Fi, which is a wired or wireless communication network.

The controller 31 may control the power of the power system to be supplied to the charging station 50 within an allowable power range of the power system based on real-time information of the power system, status information of the electric vehicles 40, and charging demand information of each electric vehicle 40.

The real-time information of the power system may include the allowable power information of the power system or the electricity rate information of the power system, the status information of the electric vehicle 40 may include the SoC information of the battery included in each of the electric vehicles 40, and the charging demand information may include a charging demand time of the electric vehicle user, an expected vehicle entry time, an expected vehicle exit time, and a charging demand amount (e.g., a target SoC).

Each of the charging stations 50 may charge the batteries of a plurality of electric vehicles 40. Each of the charging stations 50 may include an AC current limiter that performs a current allocation operation for each of the electric vehicles 40. Additionally, each of the charging stations 50 may include a control module that exchanges information with the battery management system (BMS) of the electric vehicle 40 and the controller 31. Due to the control of the controller 31, the control module may control the current limiter (e.g., the AC current limiter) to provide a DC charging current to each of the batteries of the electric vehicles 40.

Each of the electric vehicles 40 may include a battery management system (BMS). The battery management system may control a battery charging process. Each of the electric vehicles 40 may function as an active load that requests power from the electric vehicle charging/discharging management device 30 during a charging time.

A charger that converts an alternating current of the power system into direct current to charge the battery of the electric vehicle 40 may be an on-board charger included in each electric vehicle 40 or an off-board charger included in each charging station 50.

The electric vehicles 40 may participate in power transactions by registering on a V2X platform. The users of the electric vehicles 40 may join the platform according to the power market they wish to participate in and may register their expected vehicle entry and exit schedules for the next day. The electric vehicles 40 may transmit information such as an expected plug-in time, an expected plug-out time, SoC information, and available battery capacity to the electric vehicle charging/discharging management device 30.

The electric vehicle power management system 1 described above is a centralized control system that may adjust the charging/discharging schedule of the electric vehicles by considering hourly power prices or demand and supply of the power system. However, as the number of electric vehicles to be controlled increases, computational burden and complexity for optimal scheduling may also increase.

The electric vehicle charging/discharging management device according to an example embodiment may be able to optimize charging/discharging of a large-scale electric vehicle fleet.

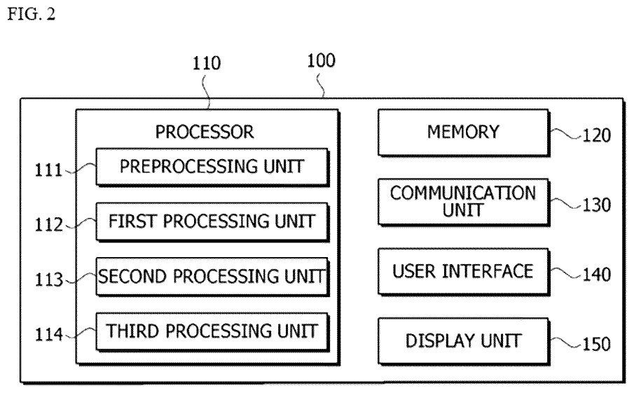

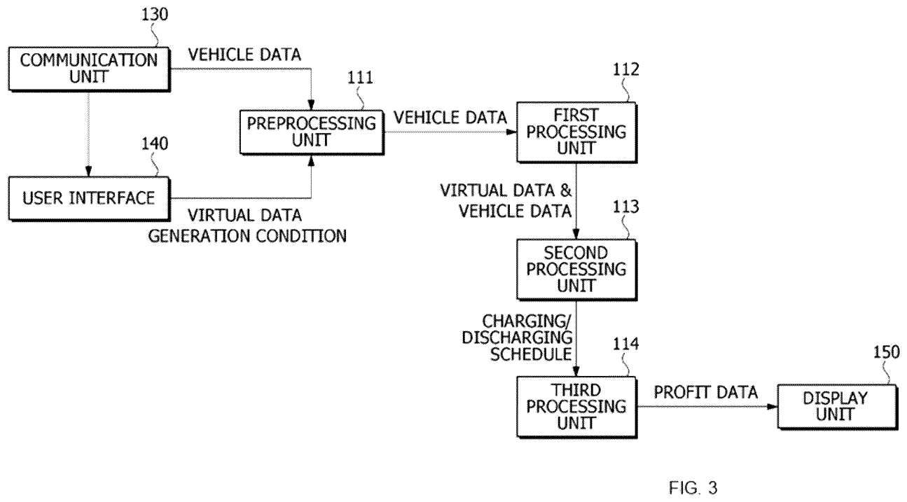

FIG. 2 is a block diagram of a configuration of the electric vehicle charging/discharging management device according to the embodiment, and FIG. 3 is a view for describing the operation of the electric vehicle charging/discharging management device according to the embodiment.

Referring to FIGS. 2 and 3, the electric vehicle charging/discharging management device 100 may include a processor 110, a memory 120, a communication unit 130, a user interface unit 140, and a display unit 150. Further, the processor 110 according to the example embodiment may include a preprocessing unit 111, a first processing unit 112, a second processing unit 113, and a third processing unit 114.

The electric vehicle charging/discharging management device 100 according to the example embodiment may be implemented in a logic circuit by hardware, firmware, software or a combination thereof, and may also be implemented using a general-purpose or special-purpose computer. The apparatus may be implemented using hardwired devices, field programmable gate arrays (FPGAs), application specific integrated circuits (ASICs), or the like. Additionally, the apparatus 100 may be implemented as a system on chip (SoC) including one or more processors and controllers.

In addition, the electric vehicle charging/discharging management device 100 may be installed in a computing device or server equipped with hardware elements in the form of software, hardware, or a combination thereof. The computing device or server may refer to various devices including all or part of a communication device such as a communication modem for communicating with various devices or wired/wireless communication networks, a memory for storing data for executing a program, a microprocessor for executing a program to perform calculations and instructions, and the like.

The memory 120 may include a database (DB). The memory 120 may be a non-transitory storage medium that stores instructions executed by the processor 110. The memory 120 may include at least one of storage media such as a random access memory (RAM), a static random access memory (SRAM), a read only memory (ROM), a programmable read only memory (PROM), an electrically erasable and programmable ROM (EEPROM), an erasable and programmable ROM (EPROM), a hard disk drive (HDD), a solid state disk (SSD), an embedded multimedia card (eMMC), a universal flash storage (UFS), and/or a web storage.

In the example embodiment, the preprocessing unit 111 and the first processing unit 112 to the third processing unit 114 may be implemented through the same process, and for convenience of description, the operation of each component will be described separately below.

The processor 110 may include at least one processing device such as an application specific integrated circuit (ASIC), a digital signal processor (DSP), a programmable logic device (PLD), a field programmable gate array (FPGA), a central processing unit (CPU), a microcontroller, and/or a microprocessor.

Additionally, each function of the processor may be implemented and operated by a module, and the operation thereof may be determined by turning each module on/off according to a user's settings.

In the example embodiment, the electric vehicle charging/discharging management device 100 may receive vehicle data through the communication unit 130 and store it in the memory 120.

In the example embodiment, the vehicle data may include plug-in charger information, a current SoC, a target SoC, source type information, battery capacity information, battery charging/discharging efficiency, expected vehicle entry time and expected vehicle exit time information, and actual plug-in time and plug-out time information.

Further, the vehicle data may include a system marginal price (SMP) and a contracted power capacity (CPC).

Furthermore, the vehicle data may include a location of a charging station, a type of vehicle being charged, and a charging station operating time.

The user interface unit 140 may generate input data for controlling the operation of the electric vehicle charging/discharging management device 100. The user interface unit 140 may be configured as a keypad, a dome switch, a touch pad, a jog wheel, a jog switch, or the like. When the display unit 150 and the touch pad are configured as a touch screen with a mutually layered structure, the display unit 150 may be used as an input device in addition to an output device.

The user interface unit 140 may receive various commands for the operation of the electric vehicle charging/discharging management device.

For example, the user interface unit 140 may receive virtual data generation conditions. In an example embodiment, the virtual data generation conditions may include an initial SoC range, a date, a period, and the number of pieces of virtual data. A user may generate virtual data for a vehicle within a desired initial SoC range by inputting the virtual data generation conditions. Additionally, the user may input the virtual data generation conditions to generate virtual data for predicting profit data for a desired date and period.

Further, the virtual data generation conditions may include location conditions. By setting the location conditions, the user may generate virtual data with conditions similar to vehicle data located near a charging station.

Further, the virtual data generation conditions may include charging vehicle type conditions. By setting the charging vehicle type conditions, the user may generate virtual data with conditions similar to vehicle data for main vehicles using the charging station.

In addition, the virtual data generation conditions may include the charging station operating time. By setting the charging station operating time, the user may generate virtual data with conditions similar to vehicle data using the charging station during an actual charging station operating time.

Referring to FIG. 3, when the user wants to simulate expected profits for 3 days starting from Jun. 25, 2024 for electric vehicles with an initial SoC of 30% to 70%, the virtual data generation conditions may be input through the user interface unit 140 according to the conditions described above. At this time, the user may also specify the number of pieces of virtual data through the user interface unit 140. In FIG. 3, it can be confirmed that the number of pieces of virtual data is specified as 1000. As the number of pieces of virtual data increases, accuracy of the expected profit data may be improved, but a process of creating and learning the virtual data may generate a lot of load. By taking this into account, the user may set the number of pieces of virtual data in various ways.

The preprocessing unit 111 may perform normalization of the vehicle data and data combination according to properties.

The preprocessing unit 111 may normalize the vehicle data input through the user interface unit 140. The preprocessing unit 111 may scale the vehicle data to a specific range to provide (e.g., enable) subsequent learning algorithms to be executed more effectively. The preprocessing unit 111 may distinguish types of vehicle data, set minimum and maximum ranges for each distinguished data type, perform processing so that a minimum value of the data converges to the minimum range and a maximum value converges to the maximum range, and then perform linear scaling so that all data values may be distributed within the minimum and maximum ranges.

The preprocessing unit 111 may generate new data by combining variables of data having interrelated characteristics in vehicle data. The term “data combination” refers to the process of integrating vehicle data variables that share interrelated characteristics to generate new data for improved learning performance. For example, the preprocessor may combine expected vehicle entry time and expected vehicle exit time to create an expected parking duration, or combine plug-in time and plug-out time to generate an actual parking duration. The term “properties” refers to temporal or functional characteristics of the vehicle data, such as time-related attributes (e.g., entry/exit times, plug-in/plug-out times), state-of-charge attributes, or charger compatibility attributes, which are logically or statistically correlated.

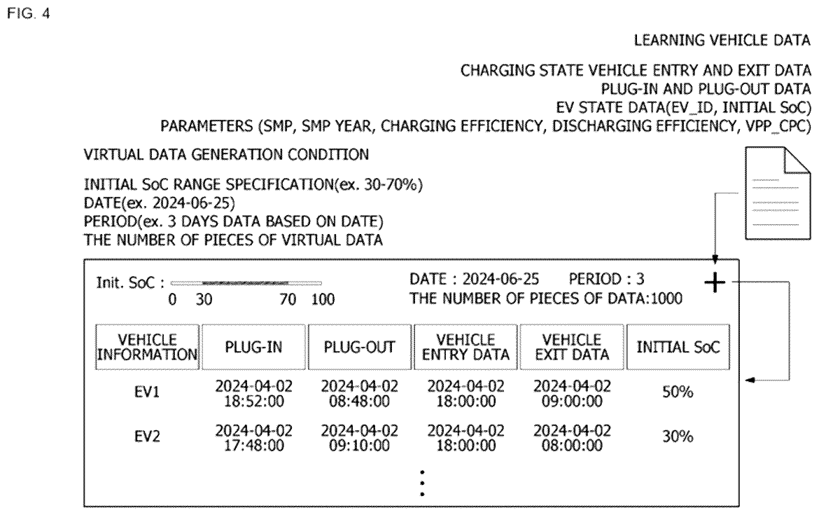

Referring to FIG. 4, the preprocessing unit 111 may generate expected vehicle entry period data by combining an expected vehicle entry time and an expected vehicle exit time which have interrelated characteristics. Also, the preprocessing unit 111 may generate actual vehicle entry period data by combining actual plug-in time and plug-out time information which have interrelated characteristics.

Through this data combination and new data generation, learning performance may be improved in a learning process of the first processing unit 112 and learning performance degradation and error occurrence due to logical errors may be prevented.

The first processing unit 112 may learn the vehicle data and generate the virtual data according to the virtual data generation conditions.

The first processing unit 112 may perform verification by comparing the virtual data with the vehicle data.

For example, the first processing unit 112 may generate virtual data by applying data augmentation, synthetic data generation, or simulation methods.

Data augmentation is a method of generating new data by modifying original vehicle data, and the first processing unit 112 may generate virtual data by adding diversity while maintaining the characteristics of the original vehicle data through data augmentation.

Synthetic data generation is a method of generating new data using an algorithm or a model, and the first processing unit 112 may generate realistic virtual data by having two neural networks (e.g., a generator and a discriminator) compete with each other, such as a generative adversarial network (GAN) model.

Alternatively, the first processing unit 112 may generate new virtual data by learning a latent representation of high-dimensional data, such as a variational autoencoder (VAE) model.

Alternatively, the first processing unit 112 may generate virtual data following a specific distribution in a regression model using a sampling method utilizing a normal distribution.

The simulation method is a method of generating virtual data by modeling specific situations or systems in the real world on a computer, and it may generate virtual data by simulating physical, biological, and economic systems.

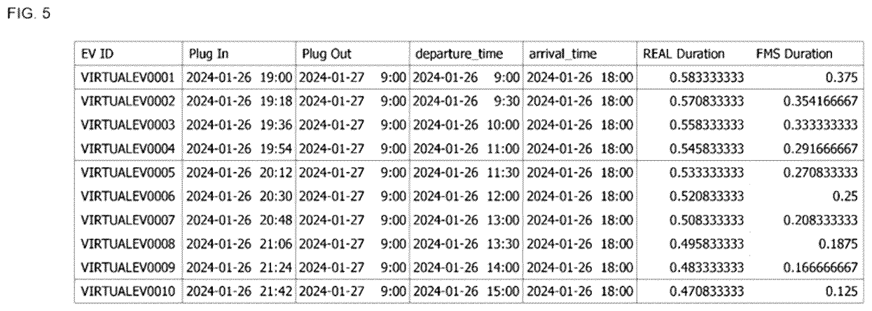

Referring to FIG. 5, the first processing unit 112 may generate virtual data based on programming rules. The first processing unit 112 may generate virtual data from vehicle data by setting a predefined specific pattern or rule.

In addition, the first processing unit 112 may generate virtual data using Tabulat GAN (TabGan). The TabGan model may refer to a GAN-based model designed to generate tabular data. The first processing unit 112 may generate virtual data from a vehicle data set in a tabular format using TabGAN.

The TabGan model may include a generator network that receives tabular vehicle data and generates virtual tabular data, and a discriminator network that receives generated virtual data and actual vehicle data and distinguishes between the two.

The generator network may operate in a direction of generating virtual data that is difficult to distinguish from real vehicle data in order to fool the discriminator network. The discriminator network performs an operation to discern virtual data, and may be designed to further improve performance thereof as it better distinguishes between real vehicle data and virtual data.

As the two networks learn competitively, the generator network may generate virtual data that is increasingly similar to real vehicle data.

The discriminator network may compare statistical properties such as the mean, standard deviation, and distribution of the generated virtual data and actual vehicle data, and check whether the main statistical indicators of the two data sets are similar.

Additionally, it is possible to use visual tools such as histograms and kernel density estimation (KDE) to check how similar distributions of the two data sets are.

Additionally, high-dimensional data may be visualized in 2D or 3D using principal component analysis (PCA), t-SNE, or the like, and then clustering structures of the actual vehicle data and the generated virtual data may be compared.

The first processing unit 112 may train the same machine learning models using the actual vehicle data and the generated vehicle data, and then compare performance thereof. For example, it is possible to check whether a model trained with the real vehicle data and a model trained with the generated virtual data have similar performance.

The first processing unit 112 may apply a model trained with the generated virtual data to the actual vehicle data to measure performance and evaluate generalization ability.

The first processing unit 112 may check whether the generated virtual data contains outliers. When there are too many outliers in the virtual data or there are patterns that appear different from the actual vehicle data, there may have been a problem in the generation process, and the first processing unit 112 may train the generator network to correct this problem.

The discriminator network may measure how similar a specific data point in the virtual data is to the real vehicle data, and check that the generated virtual data is not an exact copy of the real vehicle data.

The first processing unit 112 may retrain or tune the TabGAN model based on problems discovered during a verification process. For example, it may identify cases in which the discriminator network is too strong or the generator network is not complex enough, and may operate in a direction of improving this.

The first processing unit 112 may analyze results collected during the verification process to evaluate how well the generated virtual data matches the actual vehicle data.

For example, when a probability of distinguishing between the virtual data and the vehicle data is equal to or lower than a threshold value, the first processing unit 112 may transmit the generated virtual data and the vehicle data to the second processing unit 113 to perform learning. The threshold value is a value set in advance, and for example, when the probability of distinguishing between the virtual data and the vehicle data is 50% or less, the first processing unit 112 may transmit the generated virtual data and the vehicle data to the second processing unit 113 to perform learning.

The second processing unit 113 may perform charging/discharging scheduling using the virtual data. The second processing unit 113 may perform charging/discharging scheduling using the vehicle data corresponding to the virtual data generation conditions and the virtual data received from the first processing unit 112. The second processing unit 113 may determine whether the generated virtual data satisfies the virtual data generation conditions, and then select the virtual data and the vehicle data that meet the virtual data generation conditions to perform charging/discharging scheduling.

The second processing unit 113 may calculate a charging/discharging schedule so that an SoC at the time of the electric vehicle exiting is higher than the target SoC according to the virtual data and vehicle data. The second processing unit 113 may calculate the charging/discharging schedule using the current SoC of the electric vehicle, the battery capacity information, and the target SoC.

The charging/discharging schedule may include a charging power capacity and a discharging power capacity.

At this time, the second processing unit 113 may set the charging/discharging schedule by adjusting the SoC of the electric vehicle within a preset battery usage range. When attempting to participate in a V2X service within a range narrower than the basic upper and lower limits of a battery charging amount, this is intended to provide (e.g., ensure) that maximum optimization is performed within that range, thereby preventing errors from occurring in an optimization algorithm even when an SoC value outside the available V2X range is input or derived.

The second processing unit 113 may calculate maximum hourly charging/discharging energy using an output power capacity included in the plug-in charger information, and the expected vehicle entry time and the expected vehicle exit time. The second processing unit 113 may calculate the maximum hourly charging/discharging energy based on an output power value per hour of the charger, but in proportion to the time that the electric vehicle remains in a plugged-in state. For example, when the maximum output per hour of the charger is 10 [kW] and the plug-in time of the electric vehicle is from 10:20 to 15:00, the second processing unit 113 calculates the maximum charging/discharging energy in the first time slot (10:00 to 11:00) as 40 [minutes]/60 [minutes]*10 [kW]=6.67 [kWh], and the maximum charging/discharging energy from 11:00 to 15:00 can be calculated as 10 [kW].

The second processing unit 113 may set the charging/discharging schedule so that the SoC at the expected exit time of the electric vehicle can follow the target SoC according to the maximum hourly charging/discharging energy. The second processing unit 113 may set the charging/discharging schedule so that the SoC at the expected exit time of the electric vehicle can follow the target SoC by applying the battery charging/discharging efficiency.

The charging/discharging schedule may include an amount of the charging power capacity and an amount of the discharging power capacity of each electric vehicle. At this time, the second processing unit 113 may determine the amount of the charging/discharging power capacity of each of the electric vehicles to follow the target SoC of each of the electric vehicles. The second processing unit 113 may set the charging/discharging schedule so that a difference value between the SoC of the electric vehicle and the target SoC becomes a minimum value after actual charging or discharging according to the charging/discharging schedule. At this time, the second processing unit 113 may set an SoC upper limit and an SoC lower limit according to an available capacity range of the battery of each of the electric vehicles, and may set the charging/discharging schedule so that the electric vehicle can be charged and discharged within the range of the SoC upper limit and the SoC lower limit.

That is, the second processing unit 113 sets a difference value between the SoC of the electric vehicle after the charging/discharging control and the target SoC as an objective function, and may minimize the difference value through an optimization process of the set objective function. The second processing unit 113 may perform optimization of the objective function by applying a gradient descent method, a steepest descent method, or a stochastic gradient descent method.

The charging/discharging schedule allows a user using the V2X platform to follow a desired vehicle exit SoC input by the user, and may identify the energy (e.g., required) for charging based on the SoC at the time of vehicle entry, the target SoC, and the battery capacity information of the electric vehicle.

Further, the second processing unit 113 may calculate a charging/discharging schedule for participation in the power market according to a contracted power capacity (CPC) data included in the virtual data and vehicle data based on the charging/discharging schedule. At this time, the second processing unit 113 may calculate the charging/discharging schedule to comply with the contracted power capacity by time slot. Here, the contracted power capacity may be determined according to the previous day's bid power capacity, and as described below, the second processing unit 113 may determine the bid power with a goal of maximizing profits by selling power when the power price is high and purchasing power when the power price is low using a system marginal price (SMP) predictive value.

The second processing unit 113 may perform a function of calculating the charging/discharging schedule when the contracted power capacity is received based on results of bidding in a renewable energy bidding market. The contracted power capacity may include a charging contracted power capacity and a discharging contracted power capacity. The second processing unit 113 may calculate the charging power capacity and the discharging power capacity so that the corresponding contracted power capacity may be fully satisfied in a time slot when there is the contracted power capacity. At this time, the second processing unit 113 may calculate the charging power capacity and the discharging power capacity under a condition that the SoC of the electric vehicle follows the target SoC at the expected vehicle exit time. That is, the second processing unit 113 calculates the charging power capacity and discharging power capacity of the electric vehicle according to the contracted power capacity, but if the target SoC cannot be followed at the expected vehicle exit time when the calculated charging/discharging power capacity is applied, the amount of the calculated charging/discharging power capacity may be adjusted to follow the contracted power capacity.

That is, when the condition that the charging power capacity and the discharging power capacity follow the target SoC is not satisfied, the second processing unit 113 may modify or discard the charging/discharging schedule to adjust the charging power capacity and the discharging power capacity.

Also, the second processing unit 113 may calculate the charging/discharging schedule so that the sum of the charging efficiency and the sum of the discharging efficiency are the same. The second processing unit 113 may change the parameters according to the power market rules. The second processing unit 113 may induce the sum of the charging bid power capacities and the sum of the discharging bid power capacities derived during a bidding time (e.g., 00:00 to 24:00 of the next day) in the renewable energy bidding market to be balanced. At this time, the second processing unit 113 may bid in consideration of the charging/discharging efficiency to prevent loss in the battery charging amounts of participating users. That is, the second processing unit 113 may calculate the charging/discharging schedule so that the product of the charging power capacity and the charging efficiency is equal to the product of the discharging power capacity and the discharging efficiency. Thus, it is possible to effectively prevent SoC loss of an electric vehicle that performs the charging/discharging according to the charging/discharging schedule.

The battery charging/discharging efficiency of the electric vehicle may be determined by several factors including battery composition, charging speed, control elements of the battery management system, cables, and energy losses generated in electrical components such as power converters. The charging/discharging efficiency refers to a percentage of energy loss during a process of storing electrical energy in a battery, and this loss can occur mainly in the form of heat loss.

The second processing unit 113 may generate charging/discharging schedule information that maximizes profits based on the objective function when a charging/discharging scheduling request is made. The second processing unit 113 may set the charging/discharging schedule so that profits through the sum of a charging fee and discharging profit is maximized.

The second processing unit 113 may calculate the charging/discharging schedule using the system marginal price.

The system marginal price may refer to an indicator that determines the price of power finally supplied at a specific time slot in the power market. The second processing unit 113 may determine the system marginal price using a power demand predictive value and a bid power capacity of a power plant.

The second processing unit 113 sorts the bid power capacities from power plants that have proposed an amount and price of power to be supplied at a specific time slot in order of price, and accepts bids sequentially starting from the lowest price until the amount of power (e.g., required) to meet the power demand predictive value is supplied. The second processing unit 113 may select a point at which supply and demand match, and determine a price of the final accepted bid as the system marginal price. The determined price may represent the cost of supplying final unit power to the power system at a specific time slot. The second processing unit 113 may set the combined cost of the cost of purchasing power for charging after the charging/discharging control and the cost of selling power through the discharging as an objective function using a system marginal price predictive value, and may minimize the difference value through an optimization process of the set objective function.

The second processing unit 113 may perform the optimization of the objective function by applying a gradient descent method, a steepest descent method, or a stochastic gradient descent method.

The third processing unit 114 may calculate profit data according to results of the charging/discharging schedule. The third processing unit 114 may calculate the profit data by adding up the power purchase cost and power sales cost according to the charging/discharging schedule.

The third processing unit 114 may calculate the total charging cost by multiplying an amount of power used to charge the electric vehicle by a power rate for each time slot according to the charging/discharging schedule, and may calculate total discharging profit by multiplying an amount of discharged power by a power sales price for each time slot. The third processing unit 114 may calculate profit data by calculating a net profit by subtracting the charging cost from the discharging profit.

The display unit 150 may include at least one of a liquid crystal display (LCD), a thin film transistor-liquid crystal display (TFT LCD), an organic light-emitting diode (OLED), a flexible display, a 3D display, and an e-ink display.

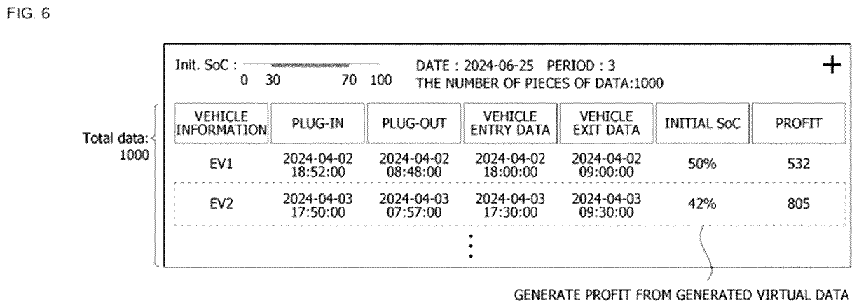

Referring to FIG. 6, the display unit 150 may display the charging/discharging scheduling results and the profit data according to control of the processor 110. Additionally, the display unit 150 may output the generated virtual data and actual vehicle data on a screen.

Further, the display unit 150 may output various user interfaces or graphical user interfaces on the screen.

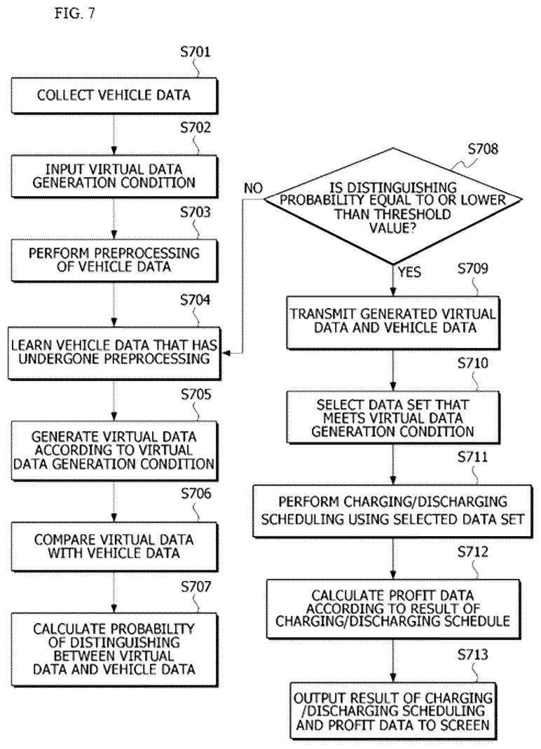

FIG. 7 is a flowchart of an electric vehicle charging/discharging management method according to an embodiment. The electric vehicle charging/discharging management method according to the embodiment may be provided to a user in the form of a mobile application, a computer program, an Internet web page service, or the like.

Referring to FIG. 7, the communication means collects vehicle data. The collected vehicle data may include plug-in charger information, a current SoC, a target SoC, source type information, battery capacity information, battery charging/discharging efficiency, expected vehicle entry time and expected vehicle exit time information, a plug-in time, and a plug-out time. Additionally, the vehicle data may include a system marginal price and a contracted power capacity (S701).

Next, the user interface unit receives the virtual data generation conditions from the user. The input virtual data generation conditions may include an initial SoC range, a date, a period, and the number of pieces of virtual data (S702).

Next, the preprocessing unit performs normalization of the vehicle data and data combination according to properties (S703).

Next, the first processing unit learns vehicle data that has undergone a preprocessing process (S704).

Next, the first processing unit generates virtual data according to the virtual data generation conditions (S705).

Next, the first processing unit compares the virtual data and the vehicle data (S706).

Next, the first processing unit calculates a probability of distinguishing between the virtual data and the vehicle data (S707).

Next, the first processing unit transmits the generated virtual data and the vehicle data to the second processing unit when the distinguishing probability is equal to or lower than a threshold value (S708 and 709).

Next, the second processing unit selects a data set that meets the virtual data generation conditions among the virtual data and vehicle data received from the first processing unit (S710).

Next, the second processing unit performs charging/discharging scheduling using the selected data set (S711).

Next, the third processing unit calculates profit data according to charging/discharging schedule results (S712).

Next, the display unit outputs the charging/discharging scheduling results and the profit data to a screen (S713).

The term “˜unit” used in this example embodiment means software or hardware components such as a field-programmable gate array (FPGA) or ASIC, and the “˜unit” performs certain roles. However, the “˜unit” is not limited to software or hardware. The “˜unit” may be configured to reside on an addressable storage medium or may be configured to cause one or more processors to be regenerated. Thus, as an example, the “˜unit” includes components such as software components, object-oriented software components, class components, and task components, and processes, functions, properties, procedures, subroutines, segments of program code, drivers, firmware, microcode, circuits, data, databases, data structures, tables, arrays, and variables. Functionality provided within the components and “˜units” may be combined into a smaller number of components and “˜units” or further separated into additional components and “˜units.” Additionally, the components and “˜units” may be implemented to reproduce one or more CPUs within a device or secure multimedia card.

An electric vehicle charging/discharging management device and method according to the example embodiment may generate virtual data for charging/discharging scheduling and profit prediction of an electric vehicle.

Additionally, it is possible to predict possible profits using the generated virtual data and provide an optimization model for this.

Additionally, it is possible to provide expected profit to a user through a user interface (UI) by a V2X platform utilizing virtual data.

Although the present disclosure has been described above with reference to example embodiments thereof, it may be understood that various modifications and changes may be made to the present disclosure without departing from the spirit and scope of the present disclosure as set forth in the claims below.

What is claimed is:

1. An electric vehicle charging and discharging management device, comprising:
a communication device configured to collect vehicle data;
a user interface configured to receive virtual data generation conditions;
a memory storing computer-executable instructions;
a first processor configured to access the memory and execute the instructions including learning the vehicle data and generating virtual data according to the virtual data generation conditions;
a second processor configured to access the memory and execute the instructions including charging and discharging scheduling using the virtual data;
a third processor configured to access the memory and execute the instructions including calculating profit data according to results of the charging and discharging scheduling; and
a display configured to display the results of the charging and discharging scheduling and the profit data.

2. The device of claim 1, wherein the vehicle data includes plug-in charger information, a current SoC, a target SoC, source type information, battery capacity information, battery charging and discharging efficiency, expected vehicle entry time information and expected vehicle exit time information, plug-in time, and a plug-out time.

3. The device of claim 1, wherein the virtual data generation conditions include an initial SoC range, a date, a period, and a number of pieces of the virtual data.

4. The device of claim 1, further comprising a preprocessor configured to normalize the vehicle data and combine interrelated vehicle data variables based on their temporal or functional characteristics.

5. The device of claim 1, wherein the instructions of the first processor comprise comparing the virtual data with the vehicle data for verification.

6. The device of claim 5, wherein the instructions of the first processor comprise learning by transmitting the generated virtual data and the vehicle data to the second processor when a probability of distinguishing between the virtual data and the vehicle data is equal to or lower than a threshold value.

7. The device of claim 1, wherein the instructions of the second processor comprise charging and discharging scheduling using the vehicle data corresponding to the virtual data generation conditions and the virtual data received from the first processor.

8. The device of claim 1, wherein the vehicle data and the virtual data generation conditions further include at least one of location conditions, a type of charging vehicle, and charging station operating time information.

9. The device of claim 8, wherein the instructions of the first processor comprise generating the virtual data using at least one of the location conditions, the type of charging vehicle, and the charging station operating time information.

10. The device of claim 1, wherein the instructions of the third processor comprise calculating the profit data by adding power purchase cost and power sales cost according to the charging and discharging schedule.

11. An electric vehicle charging and discharging management method, comprising:
collecting, by a communication device, vehicle data;
receiving, by a user interface, virtual data generation conditions;
learning, by a first processor, the vehicle data;
generating, by the first processor, virtual data according to the virtual data generation conditions;
performing, by a second processor, charging and discharging scheduling using the virtual data;
calculating, by a third processor, profit data according to results of the charging and discharging scheduling; and
displaying, via a display, the results of the charging and discharging scheduling and the profit data.

12. The method of claim 11, wherein the vehicle data includes plug-in charger information, a current SoC, a target SoC, source type information, battery capacity information, battery charging and discharging efficiency, expected vehicle entry time and expected vehicle exit time information, a plug-in time, and a plug-out time.

13. The method of claim 11, wherein the virtual data generation conditions include an initial SoC range, a date, a period, and a number of pieces of virtual data.

14. The method of claim 11, further comprising performing, by a preprocessor, normalization of the vehicle data and data combination according to properties, after the receiving of virtual data generation conditions.

15. The method of claim 11, further comprising performing, by the first processor, verification by comparing the virtual data with the vehicle data, after the generating of virtual data.

16. The method of claim 15, wherein performing the verification comprises:
comparing the virtual data with the vehicle data;
calculating a probability of distinguishing between the virtual data and the vehicle data; and
transmitting the generated virtual data and the vehicle data to the second processor when the probability is equal to or lower than a threshold value.

17. The method of claim 11, wherein performing the charging and discharging scheduling comprises using the vehicle data corresponding to the virtual data generation conditions and the virtual data received from the first processor.

18. The method of claim 11, wherein the vehicle data and the virtual data generation conditions further include at least one of location conditions, a type of charging vehicle, and charging station operating time information.

19. The method of claim 18, wherein generating the virtual data comprises using at least one of the location conditions, the type of charging vehicle, and the charging station operating time information.

20. The method of claim 11, wherein calculating the profit data comprises adding power purchase cost and power sales cost according to the charging and discharging schedule.
